(19) United States
(12) Patent Application Publication
(10) Pub. No.: US 2015/0053752 A1
(43) Pub. Date: Feb. 26, 2015

(54) BALL PLANTING DEVICE AND BALL PLANTING METHOD THEREOF

(71) Applicant: CHIPMOS TECHNOLOGIES INC, HSINCHU (TW)

(72) Inventor: TSUNG JEN LIAO, HSINCHU (TW)

(73) Assignee: CHIPMOS TECHNOLOGIES INC, HSINCHU (TW)

(21) Appl. No.: 14/285,595

(22) Filed: May 22, 2014

(30) Foreign Application Priority Data
Aug. 23, 2013 (TW) 102130157

(51) Int. Cl. B23K 3/06; B23K 1/20

(52) U.S. Cl. CPC B23K 3/0623; B23K 1/20
USPC 228/176; 428/138

(57) ABSTRACT

The present disclosure relates to a ball planting device for mounting a solder ball and a ball planting method thereof. The device includes a substrate, a dielectric layer, and a solder paste. The substrate includes a surface. The dielectric layer is disposed on the surface. The dielectric layer includes a plurality of apertures. The solder paste fills the apertures. A top surface of the solder paste is aligned with an exposed surface of the dielectric layer.

The present application claims priority from Taiwanese application Ser. No. 102130157, filed on Aug. 30, 2013, of the same title and inventorship herewith.

### BACKGROUND

1. Technical Field

The present disclosure relates to a ball planting device and, more particularly, to a ball planting device and a ball planting method without a conventional solder ball mounter.

2. Background

Current processing for mounting a solder ball requires a solder ball mounter and an expensive ball mount stencil. Since sizes of the holes of the stencil and the intervals between each of the holes cannot be adjusted for a desirable condition, it usually takes about two months to redesign the stencil for a new ball size. In addition, during the processing of mounting the solder ball, stuffing solder balls in the holes of the stencil usually occurs and causes the subsequent process to fail. Moreover, when separating the stencil from the wafer, several solder balls may drop due to the shear force from the separating operation. The current stencil cannot be applied for a wafer, of which is fabricated in a copper pillar process. Since the material of the stencil is made of metal, such as steel, metal fatigue usually causes warpage of the stencil.

### SUMMARY

The present disclosure provides a ball planting device including a substrate, a dielectric layer, and a solder paste. The substrate includes a surface. The dielectric layer is disposed on the surface and includes a plurality of apertures. The solder paste fills the apertures. A top surface of the solder paste is coplanar with an exposed surface of the dielectric layer.

The present disclosure also provides a ball planting method including the following steps. A substrate is provided. A dielectric layer is disposed on a surface. The dielectric layer is photo-lithographed, thereby forming a plurality of apertures in the dielectric layer. A solder paste is coated in the apertures. A top surface of the solder paste is coplanar with an exposed surface of the dielectric layer. A wafer layer is provided. At least one under bump metal (UBM) layer or metal pillar is disposed on a connecting surface of the wafer layer. The wafer layer and the substrate are reflowed, thereby bonding the solder paste to the at least one UBM layer or metal pillar. The dielectric layer is removed. The solder paste above the at least one UBM layer or metal pillar is reflowed to form a solder ball.

Another function of the present disclosure will be described in the following paragraphs. Certain functions can be realized in the present section, while the other functions can be realized in the detailed description. In addition, the indicated components and the assembly can be explained and achieved by the details of the present disclosure. Notably, the previous explanation and the following description are demonstrated and are not limited to the scope of the present disclosure.

### BRIEF DESCRIPTION OF THE DRAWINGS

The accompanying drawings, which are incorporated in and constitute a part of this specification, illustrate embodiments of the disclosure and, together with the description, serve to explain the principles of the invention.

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

A more complete understanding of the present disclosure may be derived by referring to the detailed description and claims when considered in connection with the Figures, where like reference numbers refer to similar elements throughout the Figures.

FIG. 1 is a schematic view of a substrate and a surface thereof in accordance with an embodiment of the present disclosure;

FIG. 2 is a schematic view of a dielectric layer disposed on the surface of the substrate in accordance with the embodiment of the present disclosure;

FIG. 3 is a schematic view of an under bump metal (UBM) layer in accordance with an embodiment of the present disclosure;

FIG. 4 is a schematic view of photo-lithographing a dielectric layer on the substrate in accordance with an embodiment of the present disclosure;

FIG. 5 is a schematic view of filling a solder paste into apertures of the dielectric layer in accordance with an embodiment of the present disclosure;

FIG. 6 is a schematic view of aligning the apertures with the at least one UBM layer in accordance with an embodiment of the present disclosure;

FIG. 7 is a schematic view of reflowing the at least one UBM layer to form a solder ball in accordance with an embodiment of the present disclosure;

FIG. 8 is a schematic view of a wafer layer including a metal pillar in accordance with an embodiment of the present disclosure;

FIG. 9 is a schematic view of aligning apertures with the at least one metal pillar in accordance with an embodiment of the present disclosure; and

FIG. 10 is a schematic view of reflowing the at least one metal pillar to form a solder ball in accordance with an embodiment of the present disclosure.

### DETAILED DESCRIPTION

The following description of the disclosure accompanies drawings, which are incorporated in and constitute a part of this specification, and illustrate embodiments of the disclosure, but are not limited to the embodiments. In addition, the following embodiments can be properly integrated to complete another embodiment.

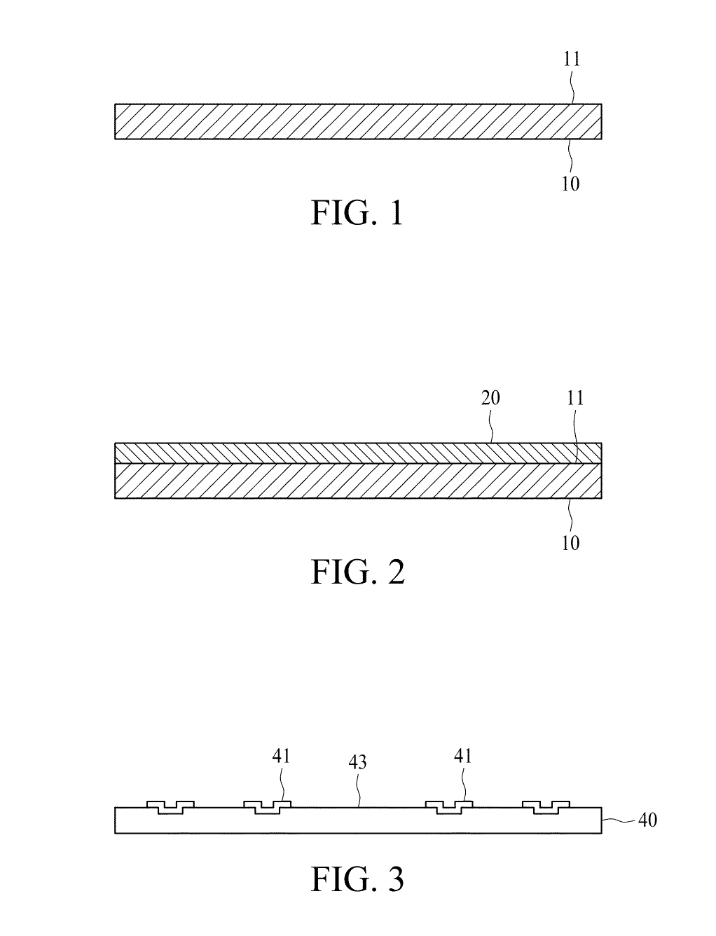

The ball planting method of the present disclosure includes several processes. As shown in FIG. 1, a substrate 10 is provided. In some embodiments, the substrate 10 includes a surface 11. In certain embodiments, the substrate 10 is a glass substrate. Since the substrate 10 is a glass substrate, metal fatigue causing warpage of the substrate 10 does not occur. In addition, the glass substrate is easily cut, and thus the dimension of the glass substrate is flexibly adjusted in accordance with different designs or requirements so as to shrink a manufacturing period of the substrate 10. Moreover, the present disclosure is cost-effective since the cost of the glass substrate is lower than that of the conventional metal stencil.

As shown in FIG. 2, the dielectric layer 20 is disposed on the surface 11. In the specification and patent scope, the term “on” means that a first member is directly or indirectly disposed above the second member. For instance, the description wherein the dielectric layer 20 is disposed on the surface 11 means two embodiments. The first embodiment means that the dielectric layer 20 is directly disposed on the surface 11. The second embodiment means that the dielectric layer 20 is indirectly disposed above the surface 11. The term “indirectly” means that in a vertical view, two members are disposed at an upper position and a lower position, respectively, while other objects, material layers, or gaps are disposed between the two members.

As shown in FIG. 3, a wafer layer 40 is provided. At least one under bump metal (UBM) layer 41 is disposed on a connecting surface 43 of the wafer layer 40.

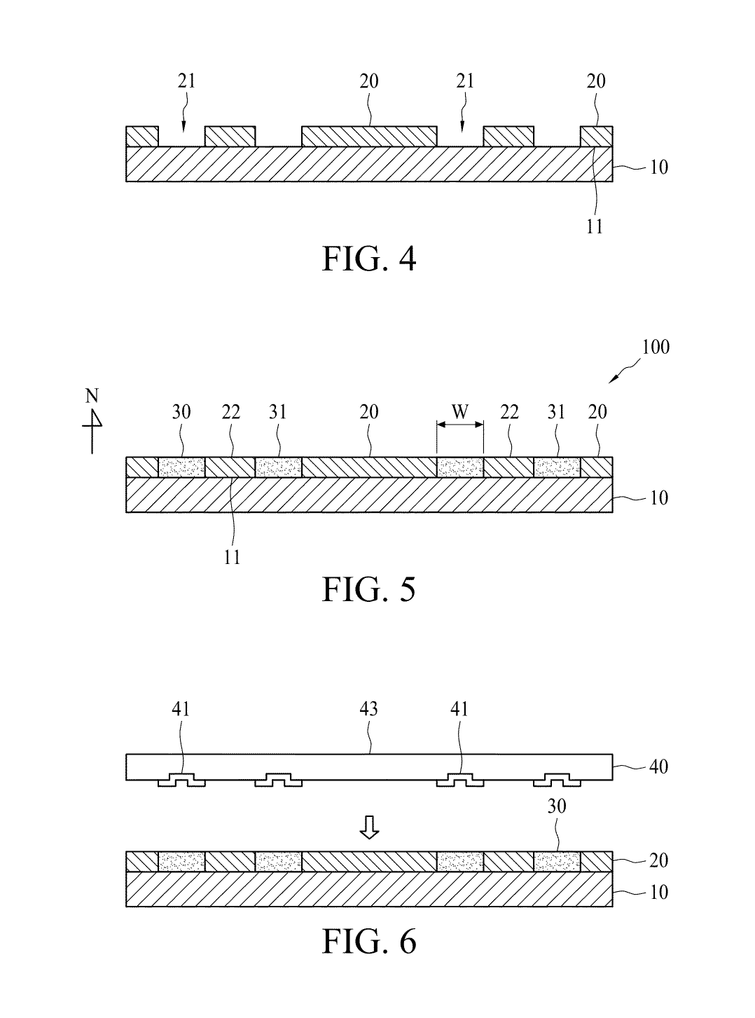

As shown in FIG. 4, the dielectric layer 20 is photo-lithographed to form several apertures 21 inside the dielectric layer 20.

As shown in FIG. 5, a solder paste 30 fills the apertures 21. In other words, the solder paste 30 is not left on an exposed surface 22 of the dielectric layer 20. Since the solder paste 30 is aligned with the exposed surface 22 of the dielectric layer 20 at the same level, a top surface 31 of the solder paste 30 is coplanar with the exposed surface 22 of the dielectric layer 20.

In some embodiments, the aperture 21 penetrates through the dielectric layer 20 and hence the solder paste 30 in the aperture 21 contacts with the surface 11 of the substrate 10. However, in other embodiments (not shown), the aperture 21 may be a blind hole, which means the aperture 21 does not completely penetrate through the dielectric layer 20. Thus, in this case, the solder paste 30 cannot contact with the surface 11 of the substrate 10.

In some embodiments as in FIG. 5, a ball planting device 100 includes the substrate 10, the dielectric layer 20, and the solder paste 30. The surface of the substrate 10 has a normal N, which is perpendicular to the surface of the substrate 10. The top surface 31 of the solder paste 30 has a predetermined width W along a direction, which is perpendicular to the normal N. The hole diameter, such as 270 μm, of the conventional stencil has to be greater than the diameter of the solder ball, such as 250 μm, so as to allow the solder ball to pass through the hole (not shown) of the stencil and to bind the UBM layer, such as 220 μm. Thus, by using the conventional stencil, the hole of the stencil cannot have a diameter that is smaller than or equal to a width of the UBM layer. In the embodiment, as in FIG. 5, the predetermined width W of the solder paste is greater than a width of the UBM layer 41. However, in another embodiment (not shown), the predetermined width W of the solder paste is either smaller than half of the width of the UBM layer 41 or equal to the width of the UBM layer 41.

As shown in FIG. 5, since the solder paste 30 fills the aperture 21, the predetermined width W is determined in accordance with the width of the aperture 21. Because the width of the aperture 21 is determined according to the photo-lithographing step, the pre-determined width W is determined in accordance with the photo-lithographing period, the photo-lithographing pattern, and the width of the UBM 41. Thus, the photo-lithographing step, as in FIG. 4, further includes a step of forming the aperture 21 with the predetermined width W along a direction perpendicular to a normal N of the substrate 10 so as to allow the top surface 31 of the solder paste to have a predetermined width W. Because the predetermined width W is determined in accordance with the photo-lithographing step, the width W is adjusted with respect to different designs. Therefore, the blocking of the solder balls in the holes of the conventional stencil does not occur in the present disclosure.

As shown in FIG. 6, the wafer layer 40 is aligned with the substrate 10 of the ball planting device 100. In other words, the aperture 21 above the substrate 10 is aligned with at least one UBM layer 41.

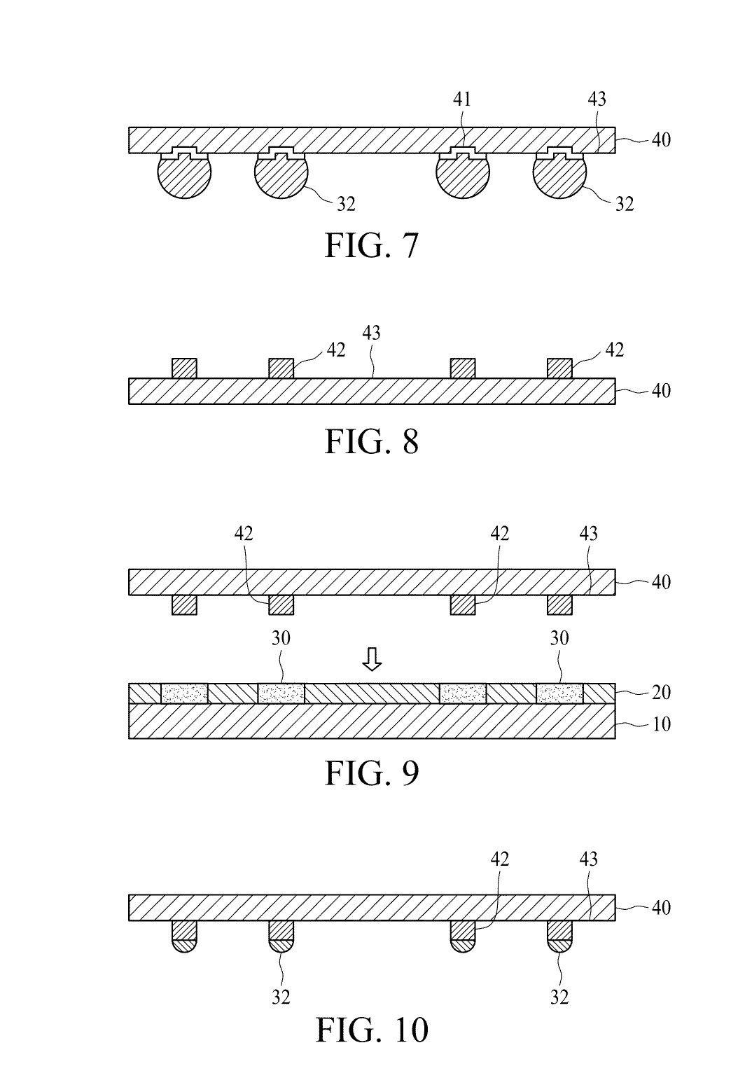

As shown in FIG. 7, the wafer layer 40 and the substrate 10 are reflowed thereby bonding the solder paste 30 to the at least one UBM layer 41. In the embodiment, the reflowing step further includes a step of connecting the wafer layer 40 to the substrate 10 so as to allow the at least one UBM layer 41 of the wafer layer 40 to be in contact with the solder paste 30.

As shown in FIG. 7, a step of removing the dielectric layer 20 further includes a step of stripping the wafer layer 40 and the substrate 10. Finally, the solder paste 30 atop or above the at least one UBM layer 41 is reflowed to form a solder ball 32 as shown in FIG. 7. Moreover, the process of removing the dielectric layer 20 utilizes a chemical agent to remove the dielectric layer 20 instead of a traditional mechanical removing operation. Therefore, when the substrate 10 is separated from the wafer layer 40, separation of the solder ball from the wafer layer due to the shear force rarely occurs.

In some embodiments as in FIG. 8, at least one metal pillar 42 is disposed on the connecting surface 43 of the wafer layer 40. In certain embodiments, the at least one metal pillar 42 is in a circular column shape or in a rectangular column shape. Several steps involved in the embodiments are previously described as in FIGS. 1 and 2. The material of the above-identified metal pillar 42 includes copper, silver, nickel, aluminum, titanium, vanadium or an alloy thereof.

As shown in FIG. 9, at least one metal pillar 42 is aligned with the solder paste 30 in the aperture 21 and penetrates into the apertures 21 so as to connect the wafer layer 40 and the substrate 10. At least one metal pillar 42 contacts with the solder paste 30. In the embodiments, the solder paste 30 has a predetermined width W along a direction perpendicular to the normal N of the substrate 10 (referring to FIG. 5). In some embodiments, as in FIG. 9, the predetermined width W is greater than a diameter of the metal pillar 42. However, in certain embodiments (not shown), the predetermined width W of the solder paste 30 is equal to the diameter of the metal pillar 42.

As shown in FIG. 10, the solder paste 30 above the at least one metal pillar 42 is reflowed so as to form a solder ball 32. Therefore, without a traditional ball mounter or stencil, the ball planting device and the ball planting method of the present disclosure are able to utilize the solder ball in a wafer, which is fabricated through a metal pillar process.

Although the present disclosure and its advantages have been described in detail, it should be understood that various changes, substitutions, and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A ball planting device, comprising:
a substrate including a surface;
a dielectric layer disposed on the surface, wherein the dielectric layer includes a plurality of apertures; and
a solder paste filled within the apertures, wherein a top surface of the solder paste is coplanar with an exposed surface of the dielectric layer.

2. The ball planting device according to claim 1, wherein the solder paste contacts with the surface of the substrate.

3. The ball planting device according to claim 1, wherein the top surface along a direction perpendicular to a normal of the substrate includes a predetermined width.

4. The ball planting device according to claim 1, wherein the substrate is a glass substrate.

5. A ball planting method, comprising:
providing a substrate;
disposing a dielectric layer on a surface;
photo-lithographing the dielectric layer to thereby form a plurality of apertures in the dielectric layer;
coating a solder paste in the apertures, wherein a top surface of the solder paste is coplanar with an exposed surface of the dielectric layer;
providing a wafer layer, wherein at least one under bump metal (UBM) layer is disposed on a connecting surface of the wafer layer;
reflowing the wafer layer and the substrate to thereby bond the solder paste to the at least one UBM layer;
removing the dielectric layer; and
reflowing the solder paste above the at least one UBM layer so as to form a solder ball.

6. The ball planting method according to claim 5, wherein the reflowing step further includes a step of connecting the wafer layer to the substrate so as to allow the at least one UBM layer to be in contact with the solder paste.

7. The ball planting method according to claim 5, wherein the photo-lithographing step further includes a step of forming the apertures along a direction perpendicular to a normal of the substrate so as to allow the top surface to have a predetermined width.

8. The ball planting method according to claim 5, wherein the substrate is a glass substrate.

9. The ball planting method according to claim 5, wherein the step of providing the wafer layer further includes a step of aligning the apertures with the at least one UBM layer.

10. The ball planting method according to claim 5, wherein the step of removing the dielectric layer further includes a step of stripping the wafer layer from the substrate.

11. A ball planting method, comprising:
providing a substrate;
disposing a dielectric layer on a surface;
photo-lithographing the dielectric layer to thereby form a plurality of apertures in the dielectric layer;
coating a solder paste in the apertures, wherein a top surface of the solder paste is coplanar with an exposed surface of the dielectric layer;
providing a wafer layer, wherein at least one metal pillar is disposed on a connecting surface of the wafer layer;
reflowing the wafer layer and the substrate to thereby bond the solder paste to the at least one metal pillar;
removing the dielectric layer; and
reflowing the solder paste above the at least one metal pillar so as to form a solder ball.

12. The ball planting method according to claim 11, wherein the reflowing step further includes a step of connecting the wafer layer to the substrate so as to allow the at least one metal pillar to be in contact with the solder paste.

13. The ball planting method according to claim 11, wherein the photo-lithographing step further includes a step of forming the apertures along a direction perpendicular to a normal of the substrate so as to allow the top surface to have a predetermined width.

14. The ball planting method according to claim 11, wherein the substrate is a glass substrate.

15. The ball planting method according to claim 11, wherein the step of providing the wafer layer further includes a step of aligning the apertures with the at least one metal pillar.

16. The ball planting method according to claim 11, wherein the step of removing the dielectric layer further includes a step of stripping the wafer layer from the substrate.

17. The ball planting method according to claim 11, wherein the at least one metal pillar penetrates into the apertures.

18. The ball planting method according to claim 11, wherein the at least one metal pillar is aligned with one of the apertures.

19. The ball planting method according to claim 11, wherein the at least one metal pillar is in a circular column shape.

20. The ball planting method according to claim 11, wherein the at least one metal pillar is in a rectangular column shape.
